(19) United States
(12) Patent Application Publication
(10) Pub. No.: US 2008/0263180 A1
(43) Pub. Date: Oct. 23, 2008

(54) APPARATUS, SYSTEM, AND METHOD FOR RESILIENT CONTENT ACQUISITION

(76) Inventors: Mark B. Hurst, Cedar Hills, UT (US); Loren D. Larsen, Lindon, UT (US); Kyle E. Powell, Orem, UT (US)

Correspondence Address: Kunzler & McKenzie, 8 EAST BROADWAY, SUITE 600, SALT LAKE CITY, UT, 84111, US

(21) Appl. No.: 11/737,669

(22) Filed: Apr. 19, 2007

(51) Int. Cl. G06F 15/16; G06F 17/30; G06F 15/173; G06F 7/00

(52) U.S. Cl. 709/219; 707/10; 707/E17.032; 709/203; 709/224

(57) ABSTRACT

An apparatus includes a directive handling module configured to implement a directive, wherein the directive defines requirements for locating, establishing, and maintaining a network connection with a remote host, and a content acquisition module configured to acquire content over a network according to the directive. A system includes a client module having the apparatus, and a directive server configured to parse a content-related request and generate a directive in response to the request. The directive may be based upon potentially sensitive business, network, location, or other policies that remain securely maintained by the directive server. A method includes implementing a directive, defining requirements for locating, establishing, and maintaining a network connection with a remote host, and acquiring content over a network according to the directive.

### BACKGROUND OF THE INVENTION

1. Field of the Invention

The invention relates to content acquisition over communications networks such as the Internet, and more particularly relates to resilient content acquisition over such networks.

2. Description of the Related Art

The Internet is fast becoming a preferred method for distributing content to end users. It is currently possible to download all types of content, including data, music and video to computers, cell phones, or practically any network capable device. For example, many portable media players are equipped with network connections and enabled to play music or videos.

In the course of retrieving content in a reliable and timely manner, a client device will encounter various types of errors. Many errors can be categorized into one of three categories: establishing, maintaining, and efficiently using TCP connections to communicate with servers. Each category has its own set of error cases that impact the relationship between the client and the server.

Typically, errors in locating servers stem from domain name system (DNS) errors. A lookup failure for a desired server, including unknown, invalid or timeout errors, are considered non-recoverable. Other types of errors related to locating or establishing a connection also include TCP connect rejection and TCP connect timeout. TCP connect rejection refers to a server that is online, but the server software is not active or the server is otherwise not accepting the TCP connection. TCP connect timeout errors refer to a server being offline, or network communication between the client and the server that is broken or congested.

One challenge in maintaining a TCP connection is the reliability of the TCP connection. Many content acquisition systems use a TCP connection, or “virtual circuit,” for transmitting data. The TCP connection provides a guaranteed delivery mechanism so that data sent from one endpoint will be delivered to the destination, even if portions are lost and retransmitted. A break in the continuity of a TCP connection can have serious consequences when the data must be delivered in real-time. When a TCP control module detects delays or losses in a TCP connection, the module “backs off” from transmission attempts for a moment and then slowly resumes the original transmission pace. This behavior is an attempt to alleviate the perceived congestion. Such a slowdown is detrimental to the viewing or listening experience of the user and therefore is not acceptable.

Relevant errors include performance timeouts, and unexpected connection terminations or resets by a server. Other examples of possible errors include, but are not limited to, HTTP request errors such as “object not found” 404 errors, similar bad headers or flawed response code errors, and server overload symptoms. Additionally, a client may experience gateway timeouts when a proxy is not successful in a DNS lookup for the server, or as the error name implies, the proxy is unable to communicate with the server.

Efficiency refers to how well the client's available bandwidth is used for delivery of the content. This is directly related to the reliability of the TCP connection. When the TCP connection is suffering reliability problems, a loss of bandwidth utilization results. The measure of efficiency sometimes varies suddenly, and can greatly impact the viewing experience.

From the foregoing discussion, it should be apparent that a need exists for an apparatus, system, and method that alleviates the problems of locating content sources and establishing, maintaining, and efficiently using TCP connections to acquire content. Additionally, such an apparatus, system, and method would offer resilient content acquisition. Beneficially, such an apparatus, system, and method would utilize policies in selecting a content server from a plurality of content servers depending upon network conditions.

### SUMMARY OF THE INVENTION

The present invention has been developed in response to the present state of the art, and in particular, in response to the problems and needs in the art that have not yet been fully solved by currently available content acquisition. Accordingly, the present invention has been developed to provide an apparatus, system, and method for resilient content acquisition that overcome many or all of the above-discussed shortcomings in the art.

The client apparatus for resilient content acquisition is provided with a logic unit containing a plurality of modules configured to functionally execute the necessary steps of resilient content acquisition. These modules in the described embodiments include a directive handling module configured to implement policy-based directives, wherein the directives define requirements for establishing, locating, and maintaining a network connection with a remote host. The apparatus also includes a content acquisition module configured to acquire content over a network according to the directives.

In one embodiment, the content acquisition module is further configured to transmit to a directive server a request that includes a reference to the content, and the directive handling module receives the policy-based directives from the directive server. The directives may be content-specific. The content acquisition module configured to locate the content, authorize the content, retrieve the content, display the content, and report statistics in accordance with the policy. In a further embodiment, the apparatus includes a directive server module configured to maintain a list of directive servers and to select a directive server for each request for directives.

The apparatus includes a server status module configured to maintain a status indicator for each of a plurality of content delivery network servers, and a broadcast module configured to broadcast content availability over a local network such that a second apparatus acquires the content from the local network. The apparatus may also include a discovery module configured to discover available content on a local network such that content is acquired from a second apparatus on the local network.

A system of the present invention is also presented for resilient content acquisition. The system includes a client module having the above described apparatus and wherein the content acquisition module is further configured to communicate a content-specific request for directives with a directive server. The system also includes a directive server is configured to parse the directive request and generate directives based on a policy or policies in response to the request for directives.

A method of the present invention is also presented for implementing a policy, defining requirements for locating, establishing, and maintaining a network connection with a remote host, and acquiring content over a network according to the policy. The method also includes transmitting a content-specific request for directives to a directive server, and receiving the policy-based directives from the directive server.

In one embodiment, the method includes locating the content, authorizing the content, retrieving the content, displaying the content, and reporting statistics in accordance with the policy-based directives. Furthermore, the method includes maintaining a list of directive servers and selecting a directive server for each directive request, and maintaining a status indicator for each of a plurality of content delivery network servers.

In a further embodiment, the method includes broadcasting content availability over a local network such that a second apparatus acquires the content from the client apparatus on the local network, and discovering available content on a local network such that content is acquired from a second apparatus on the local network.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a schematic block diagram illustrating one embodiment of a content acquisition system in accordance with the prior art;

FIG. 2 is a schematic block diagram illustrating one embodiment of a system for resilient content acquisition in accordance with the present invention;

FIG. 3 is a schematic block diagram illustrating one embodiment of a client module in accordance with the present invention;

FIG. 4 is a schematic block diagram illustrating one embodiment of a directive server in accordance with the present invention;

FIG. 5 is a schematic block diagram illustrating an alternative embodiment of a system for resilient content acquisition in accordance with the present invention;

FIG. 6 is a schematic flow chart diagram illustrating one embodiment of a method for resilient content acquisition in accordance with the present invention; and

FIG. 7 is a schematic block diagram illustrating one embodiment of a method for discovering content in accordance with the present invention.

### DETAILED DESCRIPTION OF THE INVENTION

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Reference to a signal bearing medium may take any form capable of generating a signal, causing a signal to be generated, or causing execution of a program of machine-readable instructions on a digital processing apparatus. A signal bearing medium may be embodied by a transmission line, a compact disk, digital-video disk, a magnetic tape, a Bernoulli drive, a magnetic disk, a punch card, flash memory, integrated circuits, or other digital processing apparatus memory device.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

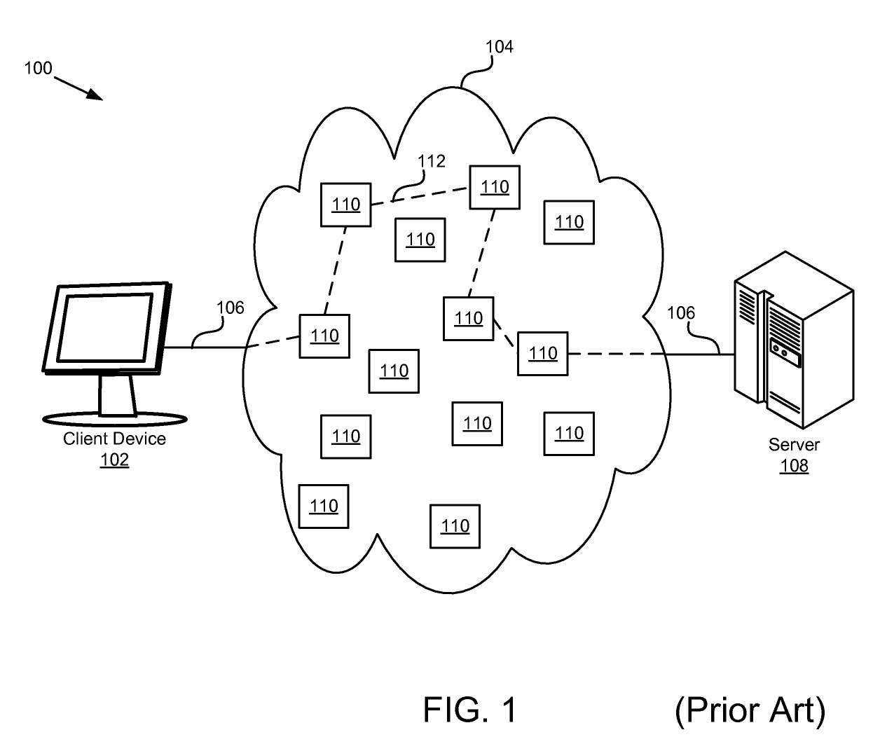

FIG. 1 is a schematic block diagram illustrating one embodiment of a content acquisition system 100 in accordance with the prior art. The system 100, in one embodiment, includes a client device 102 configured to communicate with a network 104 over a communication channel 106. The network 104 may be a global communication network such as the Internet. The communication channel 106, as illustrated, is representative of a virtual connection made by the client device 102 with a server 108 over physical connections that may comprise copper wires, fiber-optic cables, wireless connections, etc. The server 108 maintains content that is available to client devices 102 over the network 104.

The network 104 is formed of a plurality of interconnected computer networks or nodes 110 that transmit a content request from the client device 102 to the server 108 that maintains the requested content. The path 112 between the client device 102 and the server 108 is not under control of either the client device 102 or the server 108. Therefore, content acquisition is a “best effort” scenario in the sense that servers 108 are maintained in a high availability situation, and the client device 102 may be a very capable device. However, because the path 112 cannot be maintained in a similar manner, the client device may suffer from connection errors.

These errors may generally be categorized into three categories: establishing, maintaining, and efficiently using TCP connections to communicate with servers. Errors may include, but are not limited to, DNS errors, TCP connect errors, timeout errors, performance errors, and efficiency errors. Greater detail regarding the possible errors is given above with reference to the “Description of the Related Art.” Unfortunately, in the depicted embodiment, if due to some error the client device 102 is unable to establish or maintain a connection with the server 108, the only remedy an end user has is to “try again later.”

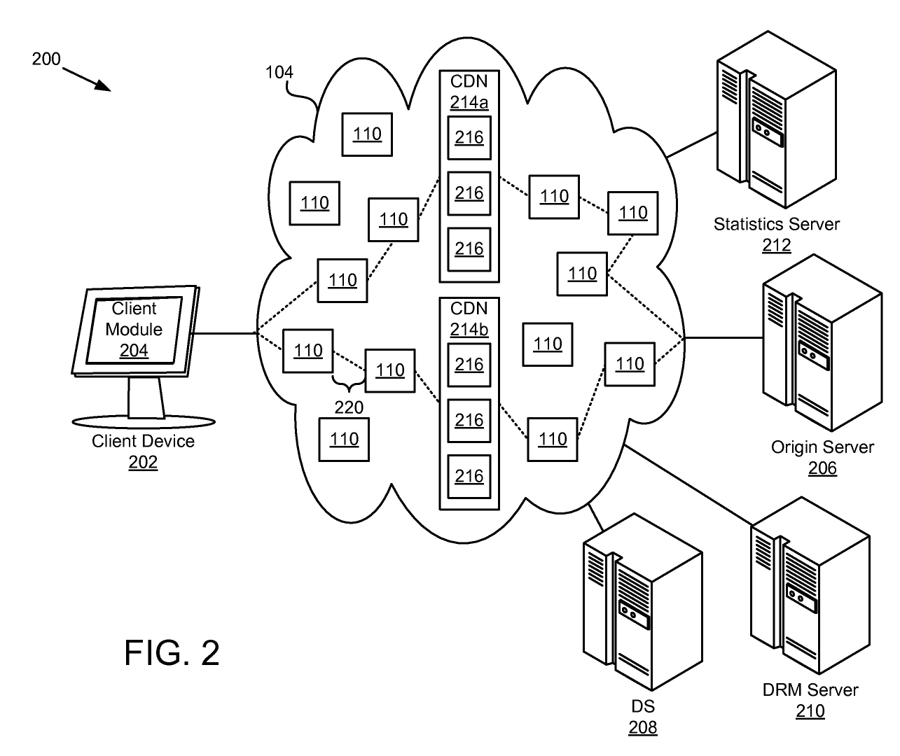

FIG. 2 is a schematic block diagram illustrating one embodiment of a system 200 for resilient content acquisition in accordance with the present invention. The system 200, in one embodiment, comprises a client device 202, a client module 204, an origin server 206, a directive server (DS) 208, a digital rights management (DRM) server 210, a statistics collection server 212, and a content delivery network (CDN) 214.

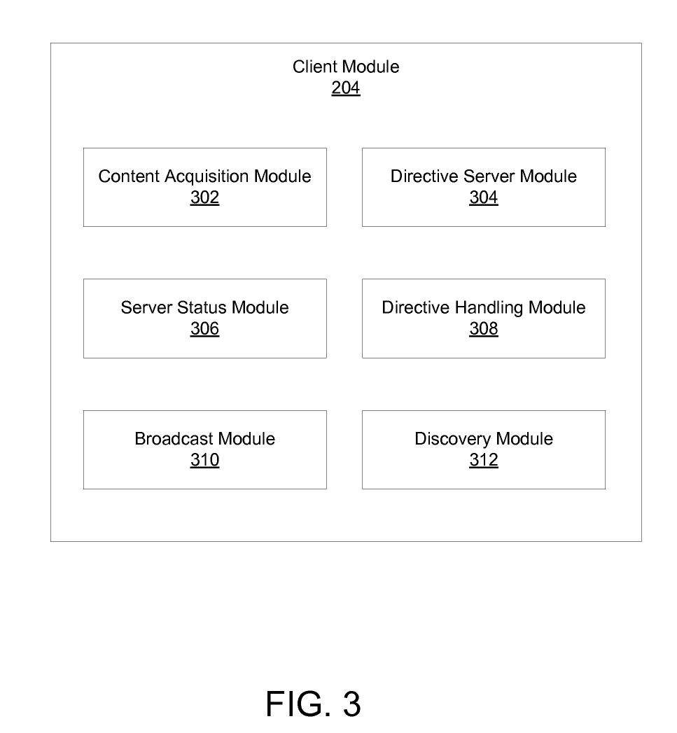

The client device 202 may comprise a personal computer (PC), an entertainment system configured to communicate over a network, or a portable electronic device configured to present content. For example, portable electronic devices may include, but are not limited to, cellular phones, portable gaming systems, portable computing devices, and portable media players. The client module 204 is configured to operate within the client device 202, request content, and acquire the content. As used herein, the term “content request” refers to the request of actual content data, where content refers to text, images, audio, video, etc., retrievable over the network 104. The client module 204 is configured to request directives from the DS 208, and subsequently implement the directives received from the DS 208. These directives instruct the client module 204 in locating, authorizing, retrieving, and reporting statistics for any selected content. The client module 204 will be discussed in greater detail below with respect to FIG. 3.

The origin server 206, in one embodiment, is a server that is accessible over the network 104 and configured to maintain content. As used herein, the term “content” refers to computer readable files including, but not limited to, data, audio, and video.

The DS 208 is configured to formulate and deliver directives to client devices 202 regarding the manner in which the client device 202 may locate, authorize, retrieve, and report statistics for requested content. The directives may be based on any number of simple or complex policies driven by network efficiency, business issues, network location relationships between the client and associated networks, or any combination of the preceeding. Policies, which may have sensitive business or privacy natures, are contained within the directive server; the policy-based directive informs the client how to behave, but not why.

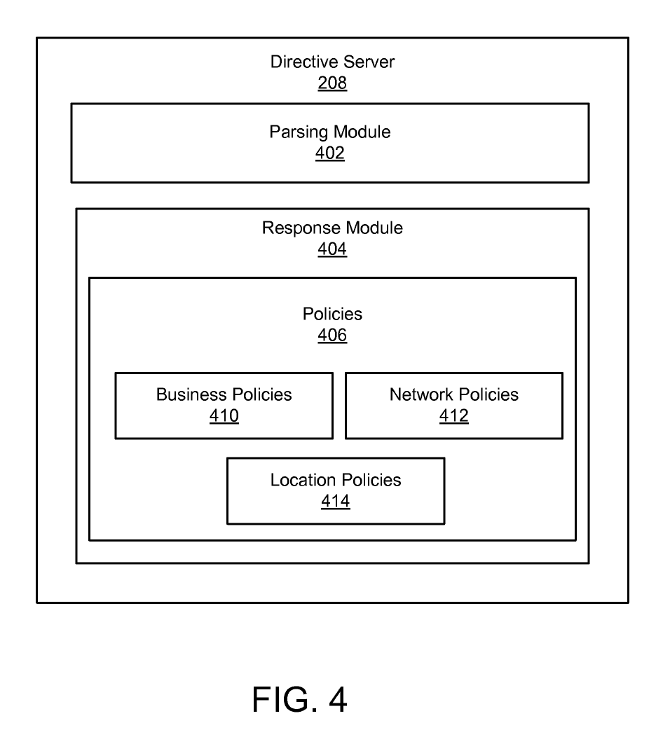

The DS 208 is further configured to recognize a content-specific directive request based upon an identifying URL of the content, source web page, or other information included in the request to the DS 208. If generating a directive for the specified content is outside of the jurisdiction of the DS 208, the DS 208 may redirect the content request to a second DS (not shown). The DS 208 will be discussed below in greater detail with reference to FIG. 4.

The DRM server 210 is configured to accept requests from client modules 204 that are attempting to acquire content that is protected under digital rights management schemes. The DRM server 210, in one embodiment, is further configured to determine the client modules 204 worthiness to access the content and return key(s) capable of decrypting digital rights management protected content. DRM schemes are well known to those skilled in the art and will not be discussed further herein.

The statistics server 212 is configured to collect content usage and client performance statistics from the client module 204. The client module 204 posts statistics to the statistics server 212 whenever the client module 204 finishes accessing a particular piece of content. This may occur when a different piece of content is selected or when the client module 204 exits a web page.

In one embodiment, statistics may include, but are not limited to what content was displayed or presented, how long the content was presented, how many advertisements were presented, and if the content is audio and/or video, at what bitrate the content was presented. The statistics may be utilized in analyzing ratings in a manner similar to television ratings, and billing.

The CDN 214 is a system of computers or nodes 216 networked across the network 104 or Internet that cooperate to deliver content to the client module 204. As depicted the nodes 216 that form the CDN 214 appear in a single location, the computers 216 or nodes may be deployed in multiple locations and over different backbone connections. Each CDN 214a, 214b comprises a plurality of computers 216 or nodes. The CDN 214 may comprise tens of thousands of nodes.

The CDN 214 directs content requests from the client module 204 to a node that is able to optimally respond to the content request. This decision may be determined by selecting the node that is located the fewest number of “hops” 220 from the client module 204. Alternatively, the CDN 214 may select a node that is “cheapest,” which oftentimes is the node that is closest to the client module 204. Examples of CDN's 214 capable of use in accordance with the present invention include, but are not limited to, Akamai of Cambridge, Mass., Limelight Networks of Tempe, Ariz. and Mirror Image Internet, Inc. of Tewksbury, Mass.

The CDN 214, in one embodiment, maintains a copy of the content hosted by the origin server 206 in order to reduce the burden on the origin server. Content requests from the client module 204 may be redirected to one of the many nodes 216 maintained by the CDN 214. The CDN 214 may utilize one of many available algorithms in redirecting a content request including, but not limited to, Global Server Load Balancing, DNS-based request routing, HTML rewriting, and proximity-based rerouting (choosing the closest node), In an alternative embodiment, the origin server 206 may be located within a CDN 214 and function as one of the nodes 216 of the CDN.

Content from the origin server 206 may be replicated to other nodes 216, which comprise primarily proxy cache servers. Replicating may occur by deliberate forwarding from the origin server 206, or by the client module 204 asking for the content, or by a web, cache, or proxy server outside of the CDN 214 asking for content on behalf of the client module 204. In a further embodiment, content may be forwarded directly to web or proxy servers through direct communication channels without the need to traverse the Internet 104.

FIG. 3 is a schematic block diagram illustrating one embodiment of a client module 204 in accordance with the present invention. In one embodiment, the client module 204 comprises a content acquisition module 302, a directive server module 304, a server status module 306, a directive handling module 308, a broadcast module 310, and a discovery module 312. The content acquisition module 302 is configured to communicate a directive server (DS) query over the network 104 (of FIG. 2) with a directive server 208.

The directive server module 304 maintains a list, or database, of available directive servers. Alternatively, the directive server module 304 may be configured with an algorithm to generate a uniform resource locator (URL) for locating a directive server 208 over the network 104 (See FIG. 2). In one embodiment, the directive server 304 is configured to randomly select one directive server 208 for each DS query. For example, the directive server module 304 may have available a list of 100 possible directive servers 208. The directive servers 208 may be distinguished by IP address or hostname. In one example, the directive servers 208 are named dsXX.somedomain.net, where XX is a number between 00 and 99. The directive server module 304, therefore, may randomly select ds47.somedomain.net when attempting to fulfill a DS query.

Randomly selecting a directive server 208 ensures that thousands or hundreds of thousands of client modules 204 do not overburden a single directive server 208. Alternatively, the directive server module 304 may employ an algorithm in selecting a directive server. Examples of such an algorithm include, but are not limited to, location-based algorithms (finding the directive server 208 that is the fewest number of hops 220 from the client), and performance-based algorithms (determined according to a performance history of the directive server 208).

The server status module 306 is configured to maintain a status indicator for each of the available servers (directive server 208, DRM server 210, statistics server, or CDN content servers 214). The server status module 306 is further configured to identify whether the server is accessible and functioning. Furthermore, the server status module 306 initially configured to assume that all servers are available until, by trial, they are proven otherwise. The status indicator for “bad” servers may then be changed by the server status module 306 to “unavailable.” The server status module 306, in a further embodiment, is configured to occasionally check the status of an “unavailable” server during content acquisition, and if successful change the status of the server to “available.”

The server status module 306 may encounter various situations which result in an “unavailable” status. These situations include, but are not limited to:
If a server cannot be located, the server status module 306 marks the server “unavailable.”
A server may have multiple IP addresses available; each IP address is tried until successful communication is established. If all fail, the server status module 304 marks the server “unavailable.”
When the client module 204 must communicate through a proxy server, the client module 204 has limited control over the ultimate discovery and communication of the server. However, under some configurations, there may be multiple IP addresses for a given proxy; each address may be tried before marking the server “unavailable.”
IP Addresses that begin to show problems (i.e., making connections, response data transfer performance is very sporadic, or horrible in comparison to other IP addresses for the same domain), are marked “unavailable” by the server status module 306.
Proxy configurations may provide at least one, and sometimes a list of multiple proxies to work with; if communication performance with the first proxy is poor, then the server status module 306 tries the next proxy. If all proxies have been tried to no avail, the server is marked “unavailable.”
Communications with servers are monitored by the server status module 306 in order to detect situations like sporadic or very high-latency responses. This is different than outright communications failure. When detected, the server status module 306 marks the server as “unavailable.”

In a further embodiment, when the server status module 306 discovers that a server is “unavailable,” and there are outstanding content requests, the content acquisition module 302 is configured to resubmit the content request to an alternate server.

The directive handling module 308 is configured to receive a directive from the directive server 208 and implement the directives in locating, authorizing, retrieving, and reporting statistics for requested content. The directive, in one embodiment, indicates locations (URL's or IP addresses of servers) where the content request may be fulfilled, locations for DRM servers 210 for authorizing or acquiring keys for presenting the content, and locations for reporting presentation statistics to the statistics server 212. Directives will be discussed in greater detail below with reference to FIG. 4.

In a further embodiment, the directive handling module 308 is configured to request an updated directive from the directive server 208 according to a predefined schedule. The schedule may be defined in the directive. For example, the directive may require that the directive handling module update the directives every 30 minutes. If no time period is defined, the directive handling module 308 may be configured with a default update cycle.

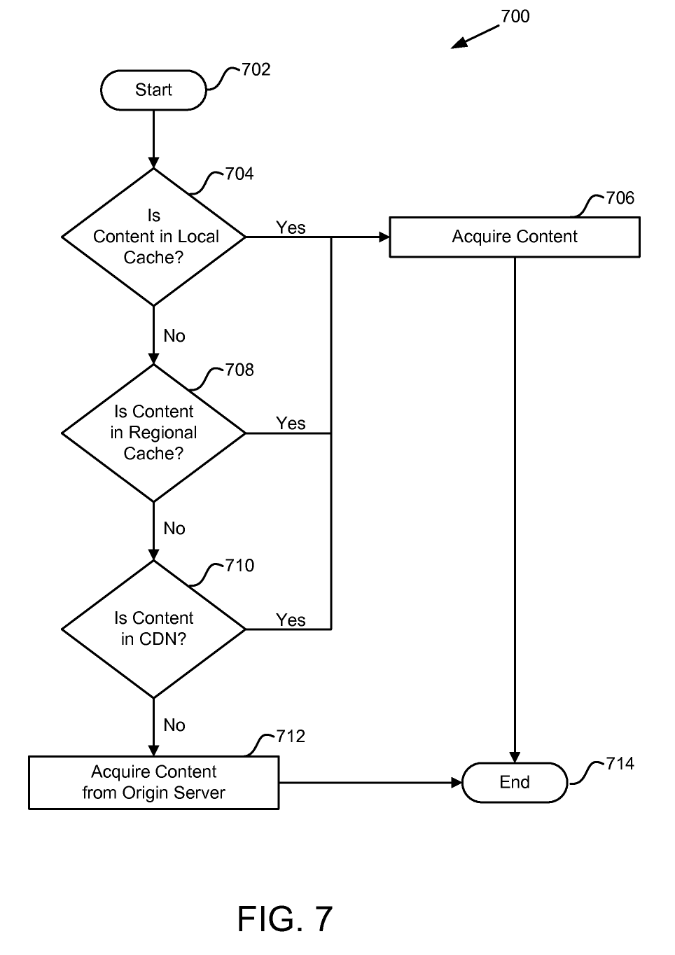

The broadcast module 310, in one embodiment, is configured to broadcast the availability of content to other client modules 204 over a network. The broadcast module 310 may first transmit a notification of the presence of a client module 204, and second the availability of content. For example, assume a first client module 204 has requested a video stream of a sporting event and has begun to successfully acquire the video stream from a server. The broadcast module 310 may then transmit a notification to other client modules 204 on the local area network of the availability of the specific sporting event. Likewise, the discovery module 312 is configured to discover available content from other client modules 204. Further discussion regarding this local or regional “sharing” will be given below with reference to FIGS. 7.

FIG. 4 is a schematic block diagram illustrating one embodiment of a directive server 208 in accordance with the present invention. In one embodiment, the directive server 208 is configured with a plurality of modules for interacting with client modules 204. These modules include a parsing module 402, and a response module 404. The parsing module 402 is configured to receive a DS query from a client module 204 and evaluate the request.

In one embodiment, evaluating the DS query from the client module 204 includes parsing the URL of the specified content. For example, if the client module 204 has requested (because an end user clicked a link on a website) an online cartoon about army ants, a URL will be transmitted to the directive server 208 that appears similar to:

http://onDemand.ContentHeaven.com/cartoons/armyants.qmx

In this example, the parsing module 402 is configured to identify the domain (ContentHeaven.com), and identify that the content specified is for army ant cartoons. Italics used in the above example are intended to indicate that the domain given is an example only, and not a valid website or domain. In a further embodiment, the parsing module 402 is configured to identify all types of content references including, but not limited to, html files, and audio and/or video files.

The response module 404 is configured to generate a directive 406 in response to the directive request and transmit this directive to the client module 204. The response module 404 considers various factors in generating a directive. These factors may include business policies 410, network policies 412, and location policies 414. One example of a business policy 410 involves a contract that a specific business may have with a specific CDN 214. For example, ContentHeaven allows for the purchase and download of a videos and utilizes multiple CDN's 214a, 214b (See FIG. 2) to deliver the videos to a client managers 204. Part of the agreement ContentHeaven has with CDN 214a may be a monthly data requirement to transfer 100 GB. However, CDN 214b may be a cheaper data provider. The business policy 410 may then direct clients to download videos from CDN 214a until 100 GB has been consumed, at which point the response module 404 begins to generate directives 406 that direct client modules 204 to acquire videos from CDN 214b. Such a business policy may be of a sensitive nature. By retaining all knowledge of the policy in the DS 208 and sending only directives to the client, the reasons behind the directives are maintained in a secure and private environment.

One example of a network policy 412 includes load balancing in order to balance the burden from client module 204 across multiple nodes 216 and CDN's 214. Other network considerations include network efficiency. The network policy 412 would influence the generation of directives that the directive server 208 returns to the client module 204 by defining rules about when and where to access content. For example, if the client module 204 detects by experience that nodes 216 in CDN 214a are not responding to requests, a directive that was based on a network policy 412 may direct the client module 204 to failover, or redirect content requests to CDN 214b. If the client module 204 determines that CDN 214a is available but performing poorly, it may failover only a proportional amount to CDN 214b and thus relieve some load on CDN 214a without suddenly burdening CDN 214b.

Location policies 414 are generated in response to the location of the client module 204. The location of a client module 204 may be determined by the IP address of the client device 202, or alternatively from an end-user profile. The response module 404 may consider the client device's location in selecting servers from which the client module 204 may acquire content. For example, if the client device 202 is a Comcast® cable-modem-connected computer, the response module 404 may be configured to specify servers that are located in the Comcast® network.

Another example of location policies 414 are region-based blackouts of certain content. For example, in order to save costs on bandwidth, a content provider may restrict streaming of a basketball game over the internet to force local viewers to watch the event on television.

The response module 404 may, in one embodiment, generate an extensible markup language (XML) file and transmit the XML file to the client module 204. One example of XML-based directives are shown below. In the following example, the term “QCD” refers to a Quantum Client Directive response. This particular example contains references to three DRM servers 210, request failover from Limelight Networks to Mirror Image Internet, and finally to default or origin servers 206, load-balancing on Mirror Image Internet servers, use of replicators, and implementations of Logical Content Partitioning (LCP) used by Limelight Networks.

1) <?xml version=“1.0” encoding=“ISO-8859-1” ?>
2) <QCD xmlns=“http://www.movenetworks.com/qcd” ver=“1.0”>
3) <QSS>
4) <URL cdn=“LLNW” priority=“1” transform=“LCP” />
5) <UrlList cdn=“Mirror” priority=“2”>
6) <URL domain=“mirror.xlontech.net” />
7) <URL domain=“mi[0-2] .xlontech.net” />
8) </UrlList>
9) <URL />
10) </QSS>
1) <DRM>
12) <URL>https://krgks[,2-3] .xlontech.net/kr</URL>
13) </DRM>
14) <Statistics>
15) <URL>joe-[x,y] .xlontech.com/stat</URL>
16) </Statistics>
17) <Transforms>
18) <LCP select=“qmplive* $$*foxvod/pb*” live=“300”
19) vhost=“move-live-$1.vo.llnwd.net”
20) partitions=“1000”
21) rollover=“12” />
22) <LCP select=“qmplive*”
23) vhost=“move-od-$1.vo.llnwd.net”
24) partitions=“1000”
25) rollover=“60” />
26) </Transforms>
27) </QCD>

The above example illustrates one example of a response generated by the response module 404. The literal definitions of the elements, attributes, tags, and values shown above will now be given, but are given herein by way of example only. One skilled in the art will recognize that although XML is shown as one example of a policy generated by the response module 404, a policy may be generated in any kind of ASCII, or binary file, or alternatively as an executable delivered to the client module 204 and executed on the client device 202.

<URL>: This element is used to define a URL value. The value may be given explicitly as the element's text value or constructed dynamically by applying various substitutions and/or transformations to a known reference URL value. The parts of a URL as referred to in this document are protocol schema, host, domain, port, path, and file. (The “http://” protocol schema text is not required in any URLs. Any other schemas, such as “https://”, must be specified.) For example, a complete URL may consist of:

ds01.x_ontech.net:2779/roadrunner/output.qmx

Where the protocol schema is assumed to be “http://”, host is “ds01”, domain is “xlontech.net”, port is “2779”, path is “/roadrunner/”, and the filename is “output.qmx”. In some contexts, the URLs may be missing the filename, or filename and path.

The <URL> element has several optional attributes that define how the response module 404 may construct a URL given the content's original reference URL (of which the URL above is an example) as a starting point, these include:
Substitution. Any text may be substituted in place of any part of the new URL. For example, forming the new URL so that a streamlet request would use a different CDN might be made with a domain name substitution.
Replicator Expansion. A “replicator” definition is a series of one or more comma-separated items of text and/or numeric ranges enclosed in square brackets (“[ ]”). A simple example is “[01-02,X]”. The replicator is “expanded” by generating a new <URL> element for each unique (or implied by numeric range) item in the definition, and substituting the corresponding expansion text into each new URL value.
Transformation. Any URL value can be processed by a “transform”. The transform accepts a URL string value as input and can generate a new URL value that will then become the final, effective URL value for that <URL> element.

The <URL> element has several attributes. Examples of these attributes include, but are not limited to, cdn, priority, and transform. The cdn attribute's value gives the name of the CDN 214 that will be used to route the content request. In this example, the cdn value refers to Limelight Networks (line 4). The priority attribute specifies the relative priority of network paths which the client must honor when selecting among a plurality of CDNs 214. The transform attribute specifies a transformation algorithm to apply when generating the final value of a <URL> element, as described earlier. The <URL> element on line 5 identifies use of the Mirror Image CDN with a priority of 2. This combination of directives would indicate to the client module 204 that content will be acquired from Limelight Networks except that in the event of failures the content may be acquired from the Mirror Image CDN.

<QSS>: Identifies servers by URL (using the <URL> elements) where the actual content can be obtained. In this example the term “QSS” refers to quantum streamlets that are encapsulated media files as described in U.S. Patent Application Publication No. US-2005-0262257, which is incorporated herein in its entirety.

<Transforms>: This container element holds transform elements, each with their own set of attributes or sub elements. Each transform is declared as an element using the transform name as the XML tag name. Transforms are invoked by reference from the transform attribute of <URL> elements. An example appears on line 4. A transform accepts as input the URL value(s) already formed by substitutions (if any) and replications (if any). The transform produces a new URL which then becomes the final, effective value of the <URL> element. One example of a transform is Limelight Networks LCP algorithm (lines 18-26). Alternatively, any URL transforming algorithm may be utilized.

<DRM>, and <Statistics> (line 11, and line 14) identify servers by URL (using <URL> elements) where DRM keys may be obtained and where statistics may be posted, respectively

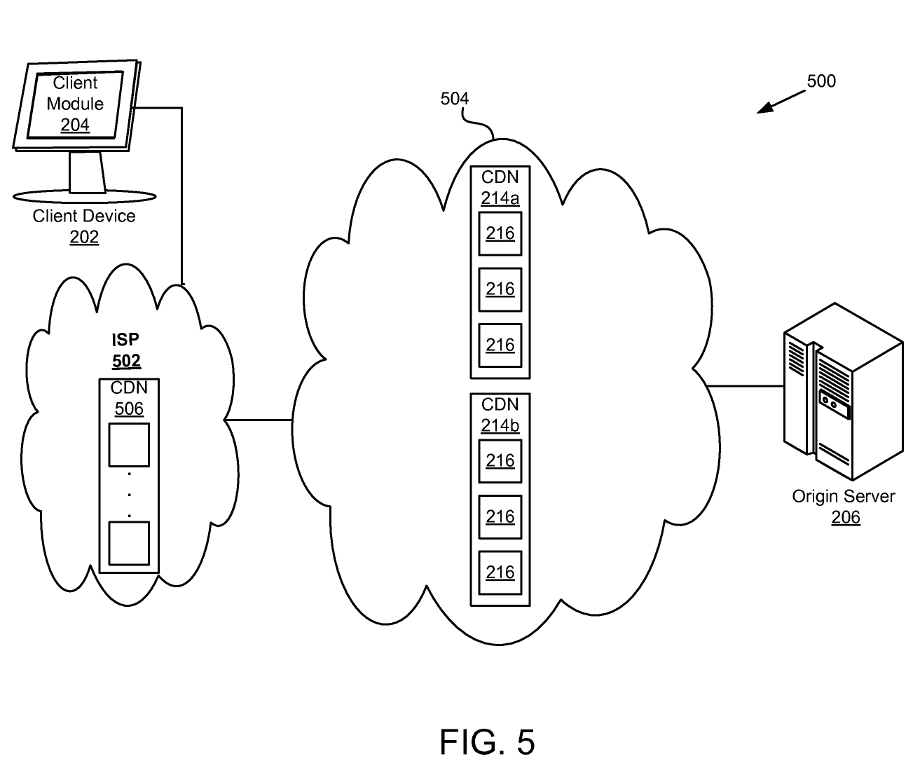

FIG. 5 is a schematic block diagram illustrating an alternative embodiment of a system 500 for resilient content acquisition in accordance with the present invention. The system 500 depicts the client device 202 connected to an Internet Service Provider (ISP) 502. The ISP 502 provides the client device 202 a pathway to connect to the Internet 504. ISP's 502 typically implement multiple web servers or proxy cache servers to replicate content requests from client modules 204. This is done to save bandwidth costs. Replicating may occur by deliberate forwarding from the origin server 206, or by the client module 204 asking for the content, or by a web, cache, or proxy server outside of the origin server 206 asking for content on behalf of the client module 204. In a further embodiment, content may be forwarded directly to web or proxy servers through direct communication channels without the need to traverse the Internet 106.

In one embodiment, the ISP 502 implements a CDN 506 formed of nodes represented by boxes 508a through 508n. The nodes 508 may be proxy cache servers or other networking modules. One benefit of implementing an ISP-specific CDN 502 is the cost savings in reducing the bandwidth the ISP 502 transmits and receives from the Internet 504. Additionally, the ISP 502 may realize a source of income by delivering “pay-per-view” content.

The schematic flow chart diagrams that follow are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

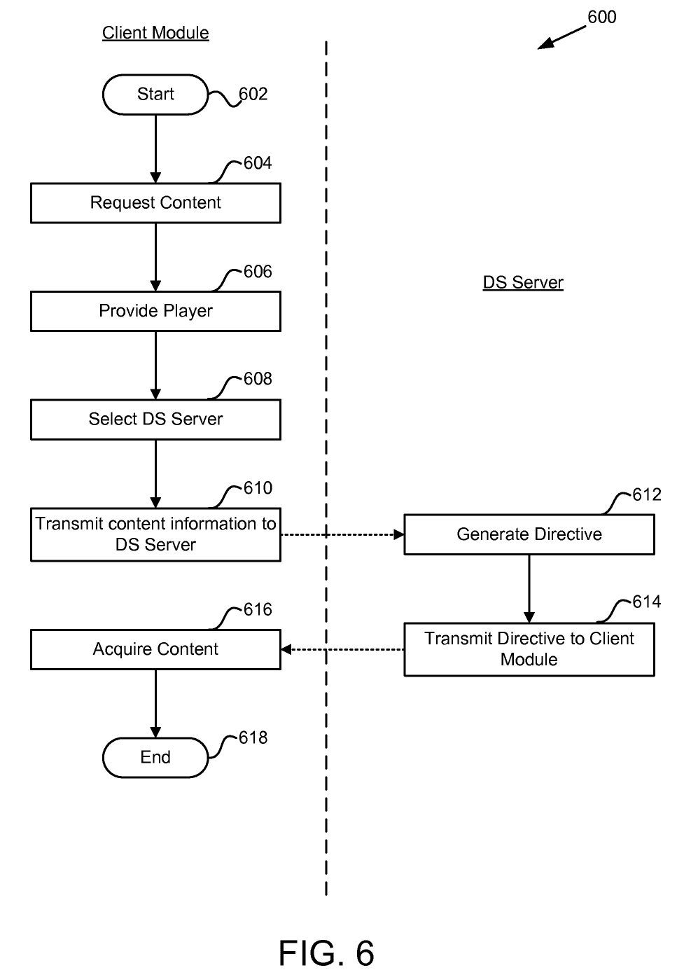

FIG. 6 is a schematic flow chart diagram illustrating one embodiment of a method 600 for resilient content acquisition in accordance with the present invention. In one embodiment, the method 600 starts and the client module 204 (of FIG. 2) requests 604 content. Requesting 604 content, in one embodiment, may comprise clicking on a link on a website in order to open a new website, download a file, view a video, listen to a song, etc. If the content is of the type that requires a player (i.e. audio or video) then the client module 204 provides 606 a player. Providing 606 a player may comprise creating an instance of an already installed media player within a browser or alternatively downloading and creating an instance of a player. The directive server module 304 then selects 608 a directive server as described above with reference to FIG. 3.

The content acquisition module 302 then creates a DS query and transmits 610 content information to the selected directive server 208. In one embodiment, transmitting 610 content information comprises transmitting a URL of the requested content. The directive server 208 receives the content information and generates 612 a directive in response to the content information. As described above with reference to FIG. 4, generating a directive may comprise parsing the content request URL and generating a directive based upon the specific content request and predefined policies including business, network, and location policies.

The response module 404 then transmits 614 the directive to the client module 204. The directive handling module 308 of the client module 204 receives the directive and implements the directive in acquiring 616 the content. The method 600 then ends 618.

FIG. 7 is a schematic block diagram illustrating one embodiment of a method 700 for discovering content in accordance with the present invention. In one embodiment, the method 700 starts and a client module 204 (See FIG. 2) requests content. The client module 204 first verifies if the content is 704 in the local cache. If the content can be found in a local cache on the client device 202 then the content module 204 acquires 706 the content.

If the content is not 704 in the local cache then the discovery module 312 looks on a local or regional network for the content. Alternatively, the client module 204 may begin downloading the content from a CDN 214, 506, and if the discovery module 312 finds the content on a device coupled with the local network the content acquisition module 302 may begin to acquire 706 the content from the locally connected device.

If, however, the discover module 312 is unable to find 708 content in the regional or local cache, the content acquisition module 302 proceeds or continues acquiring 706 from the CDN 214, 506. If for some reason the content is not 710 available from any CDN 214,506, the client module 204 may be configured to acquire 712 the content from the origin server 206. The method 700 then ends 714.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An apparatus for resilient content acquisition, the apparatus comprising:
a directive handling module configured to implement a directive;
wherein the directive defines requirements for establishing, locating, and maintaining a network connection with a remote host; and
a content acquisition module configured to acquire content over a network according to the directive.

2. The apparatus of claim 1, wherein the content acquisition module is further configured to transmit a directive server query to a directive server.

3. The apparatus of claim 2, wherein the directive handling module is further configured to receive the directive from the directive server.

4. The apparatus of claim 1, wherein the content acquisition module is further configured to locate the content, authorize the content, retrieve the content, display the content, and report statistics in accordance with the directive.

5. The apparatus of claim 1, further comprising a directive server module configured to maintain a list of directive servers and to select a directive server for each directive request.

6. The apparatus of claim 1, further comprising a server status module configured to maintain a status indicator for each of a plurality of content delivery network servers.

7. The apparatus of claim 1, further comprising a broadcast module configured to broadcast content availability over a network such that a second apparatus acquires the content from the apparatus over the network.

8. The apparatus of claim 1, further comprising a discovery module configured to discover available content on the network such that content is acquired from a second apparatus.

9. The apparatus of claim 1, wherein the directive is further configured to identify a plurality of backup remote hosts.

10. A system for resilient content acquisition, the system comprising:
a client module in communication with a network, the client module comprising:
a directive handling module configured to implement a directive;
wherein the directive defines requirements for establishing, locating, and maintaining a network connection with a remote host;
a content acquisition module configured to acquire content over the network according to the directive;
wherein the content acquisition module is further configured to communicate a directive server query with a directive server; and
wherein the directive server is configured to parse the content request and generate a directive in response to the content request.

11. The system of claim 10, wherein the directive handling module is further configured to receive the directive from the directive server.

12. The system of claim 10, wherein the content acquisition module is further configured to locate the content, authorize the content, retrieve the content, display the content, and report statistics in accordance with the directive.

13. The system of claim 10, further comprising a directive server module configured to maintain a list of directive servers and to select a directive server for each directive request.

14. The system of claim 10, further comprising a server status module configured to maintain a status indicator for each of a plurality of content delivery network servers.

15. The system of claim 10, further comprising a broadcast module configured to broadcast content availability over a local network such that a second apparatus acquires the content from the apparatus over the network.

16. The system of claim 10, further comprising a discovery module configured to discover available content on a network such that content is acquired from a second apparatus.

17. A method for resilient content acquisition, the method comprising:
implementing a directive;
defining requirements for locating, establishing, and maintaining a network connection with a remote host; and
acquiring content over a network according to the directive.

18. The method of claim 17, wherein the method further comprises transmitting a directive server query to a directive server.

19. The method of claim 18, wherein the method further comprises receiving the directive from the directive server.

20. The method of claim 17, wherein the method further comprises locating the content, authorizing the content, retrieving the content, displaying the content, and reporting statistics in accordance with the directive.

21. The method of claim 17, wherein the method further comprises maintaining a list of directive servers and selecting a directive server for each directive request.

22. The method of claim 17, wherein the method further comprises maintaining a status indicator for each of a plurality of content delivery network servers.

23. The method of claim 17, wherein the method further comprises broadcasting content availability over a local network such that a second apparatus acquires the content from the apparatus over the network.

24. The method of claim 17, wherein the method further comprises discovering available content on a network such that content is acquired from a second apparatus.

25. A computer program product comprising a computer useable medium having a computer readable program, wherein the computer readable program when executed on a computer causes the computer to carry out operations for resilient content acquisition, the operations comprising:
implementing a directive;
defining requirements for establishing, locating, and maintaining a network connection with a remote host; and
acquiring content over a network according to the directive.

26. The computer readable program of claim 25, wherein the operations further comprise transmitting a directive server query to a directive server.

27. The computer readable program of claim 26, wherein the operations further comprise receiving the directive from the directive server.

28. The computer readable program of claim 25, wherein the operations further comprise locating the content, authorizing the content, retrieving the content, displaying the content, and reporting statistics in accordance with the directive.

29. The computer readable program of claim 25, wherein the operations further comprise maintaining a list of directive servers and selecting a directive server for each directive request.

30. The computer readable program of claim 25, wherein the operations further comprise maintaining a status indicator for each of a plurality of content delivery network servers.

31. The computer readable program of claim 25, wherein the operations further comprise broadcasting content availability over a local network such that a second apparatus acquires the content from the apparatus over the network.

32. The computer readable program of claim 25, wherein the operations further comprise discovering available content on a network such that content is acquired from a second apparatus.

33. An apparatus for resilient content acquisition, the apparatus comprising:
means for implementing a directive;
means for defining requirements for establishing, locating, and maintaining a network connection with a remote host; and
means for acquiring content over a network according to the directive.

34. An apparatus for resilient content delivery, the system comprising:
a parsing module configured to receive a content request from a source and identify content information;
a response module configured to generate a directive in response to the content information,
wherein the directive defines requirements for establishing, locating, and maintaining a network connection with a remote host; and
wherein the response module is further configured to communicate the directive with the source.

35. The apparatus of claim 34, wherein the content information is selected from a group consisting of host, domain, content request source, path, and content name.

36. The apparatus of claim 34, wherein the response module is further configured to update and communicate the directive with the source.
